(19) United States
(12) Patent Application Publication
(10) Pub. No.: US 2021/0326896 A1
(43) Pub. Date: Oct. 21, 2021

(54) AUTOMATICALLY SUGGESTING MACROS TO HELP AGENTS PROCESS TICKETS IN AN ONLINE CUSTOMER-SUPPORT SYSTEM

(71) Applicant: Zendesk, Inc., San Francisco, CA (US)

(72) Inventors: Ai-Lien Tran-Cong, San Francisco, CA (US); Anh Thien Dinh, San Mateo, CA (US); Stephanie C. Olding, San Francisco, CA (US); Christopher J. Hausler, Coburg (AU); Eleanor B. Stribling, San Francisco, CA (US); Hing Yip Pak, Brunswick (AU); Pasindu V. Dissanayake, Mulgrave (AU); Akhil Naru, Providence, RI (US)

(73) Assignee: Zendesk, Inc., San Francisco, CA (US)

(21) Appl. No.: 16/854,651

(22) Filed: Apr. 21, 2020

(51) Int. Cl. G06Q 30/00; G06N 3/04; G06Q 10/10; G06F 9/451; G06F 40/166

(52) U.S. Cl. CPC G06Q 30/016; G06N 3/04; G06F 40/166; G06F 9/453; G06Q 10/10

(57) ABSTRACT

We have developed a system that automatically suggests macros to help customer-support agents process customer-support tickets in an online customer-support system. During operation, the system receives a customer-support ticket, which is associated with a request from a customer in the customer-support system, wherein the request relates to a product or a service used by the customer. Next, the system converts text from the customer-support ticket into a ticket embedding in a vector space. The system then feeds the ticket embedding into a macro-suggestion model, which correlates ticket embeddings with macros, wherein each of the macros comprises a sequence of commands that performs an operation to facilitate processing of the customer-support ticket. If the macro-suggestion model produces suggested macros, the system presents the suggested macros to a customer-support agent. When the customer-support agent selects a suggested macro, the system facilitates application of the selected macro to the customer-support ticket.

### BACKGROUND

### Field

The disclosed embodiments generally relate to the design of customer-support resources for ecommerce systems. More specifically, the disclosed embodiments relate to a customer-support system that automatically suggests macros to help agents process customer-support tickets.

### Related Art

As electronic commerce continues to proliferate, customers are beginning to use online customer-service resources to solve problems, and to obtain information related to various products or services. These online customer-service resources commonly include customer-support ticketing systems, which are designed to help customers, by: providing helpful information to the customers; directing customers to specific workflows; or facilitating interactions with customer-support agents. When designed properly, these online customer-support resources can automate many customer-support interactions, thereby significantly reducing a company's customer-support costs.

While processing tickets, customer-support agents often make use of macros, comprising sequences of commands, to perform various operations to facilitate processing of tickets. For example, macros can be used to add notes or tags to tickets, update ticket fields, or change the priority of a ticket. Macros improve agent efficiency by reducing the amount of time agents spend manually entering commands. However, teams of customer-support agents typically create and use large numbers of macros, and this makes it difficult for agents to quickly locate the most-relevant macros to process a ticket. Agents also find it difficult to keep up-to-date with new or updated macros.

Hence, what is needed is a customer-support system that helps customer-support agents locate the most relevant and up-to-date macros to facilitate processing specific customer-support tickets.

### SUMMARY

The disclosed embodiments relate to a system that automatically suggests macros to help customer-support agents process customer-support tickets in an online customer-support system. During operation, the system receives a customer-support ticket, which is associated with a request from a customer in the customer-support system, wherein the request relates to a product or a service used by the customer. Next, the system converts text from the customer-support ticket into a ticket embedding in a vector space. The system then feeds the ticket embedding into a macro-suggestion model, which correlates ticket embeddings with macros, wherein each of the macros comprises a sequence of commands that performs an operation to further processing of the customer-support ticket. If the macro-suggestion model produces suggested macros, the system presents the suggested macros to a customer-support agent. Then, if the customer-support agent selects a suggested macro, the system facilitates application of the selected macro to the customer-support ticket.

In some embodiments, if none of the suggested macros is relevant, the system enables the customer-support agent to provide feedback for the macro-suggestion model.

In some embodiments, while facilitating application of the selected macro to the customer-support ticket, the system executes a sequence of commands from the selected macro to generate modifications to the customer-support ticket. The system then enables the customer-support agent to commit the modifications to the customer-support ticket.

In some embodiments, after executing the sequence of commands from the selected macro, the system allows the customer-support agent to manually modify the customer-support ticket prior to committing the modifications.

In some embodiments, after one or more modifications are committed to a customer-support ticket, the system performs one or more cascading actions based on the committed modifications.

In some embodiments, while converting the text from the customer-support ticket into the ticket embedding, the system applies a universal sentence encoder to the text (such as the Google Universal Sentence Encoder™) to produce the ticket embedding.

In some embodiments, the macro-suggestion model operates by first using a binary classifier to determine whether any macros are applicable to the ticket. If so, the system uses a recommendation model to return the suggested macros, wherein the suggested macros comprise a subset of the macros that have the highest probabilities of being applicable to the ticket.

In some embodiments, the macro-suggestion model includes a feed-forward neural network.

In some embodiments, prior to receiving the customer-support ticket, the system trains the macro-suggestion model. During this process, the system obtains a training data set comprising a set of observations, wherein each observation includes text from a customer-support ticket and an associated identifier for a macro that a customer-support agent manually applied to the customer-support ticket. The system then trains the macro-suggestion model based on the training data set.

In some embodiments, an account-specific macro-suggestion model is used to process customer-support tickets associated with each account in the customer-support system.

In some embodiments, the system additionally filters suggested macros based on agent groups so that certain macros are accessible by specific agents or specific groups of agents.

In some embodiments, the macros can perform one or more of the following operations on customer-support tickets: modifying a ticket field; adding a comment to a ticket; adding an attachment to a ticket comment; adding a cc to a ticket; adding or removing a ticket tag; changing a priority of a ticket; setting or changing a subject of a ticket; setting or changing a status of a ticket; setting or changing an assignee of a ticket; and modifying a custom field in a ticket.

### BRIEF DESCRIPTION OF THE FIGURES

FIG. 1 illustrates a computing environment including an application and an associated customer-support system in accordance with the disclosed embodiments.

FIG. 2 illustrates components in a customer-support system in accordance with the disclosed embodiments.

FIG. 3 illustrates an exemplary user interface (UI) that provides macro suggestions in accordance with the disclosed embodiments.

FIG. 4 presents a flow chart illustrating operations performed during the macro-suggestion process in accordance with the disclosed embodiments.

FIG. 5 presents a flow chart illustrating operations performed while accessing the macro-suggestion model in accordance with the disclosed embodiments.

FIG. 6 presents a flow chart illustrating operations performed while training the macro-suggestion model in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

The disclosed embodiments provide a macro-suggestion service that uses historical macro usage and context associated with a ticket object, such as text in the ticket, the arrival time of the ticket, the identity of the customer associated with the ticket, and the communication channel associated with the ticket (e.g., email, SMS, social media), to identify the most likely relevant macros to apply to a new, incoming customer-support ticket. During operation, this macro-suggestion service receives a prediction request from a customer-support agent UI. In response, the macro-suggestion service retrieves relevant ticket data, and then makes use of a model that ingests the ticket data and identifies the most relevant macros based on recent macro usage for the account. This macro-suggestion service then filters the identified macros based on user permission, and returns them to be presented to a customer-support agent through a customer-support agent UI.

From an agent's perspective, the most relevant macros for the ticket are presented prominently in the UI, which saves them from having to search through large numbers of macros to find the right one. The customer-support agent can then apply any or all of the presented macros to perform various operations on the ticket, such as adding a comment to the ticket, changing the priority of the ticket, adding a tag to the ticket, and amending a custom field that the agent has configured in the ticket. If none of the recommendations is relevant, the customer-support agent could provide feedback for the macro-suggestion model.

Before describing this macro-suggestion process further, we first describe the computing environment in which it operates.

### Computing Environment

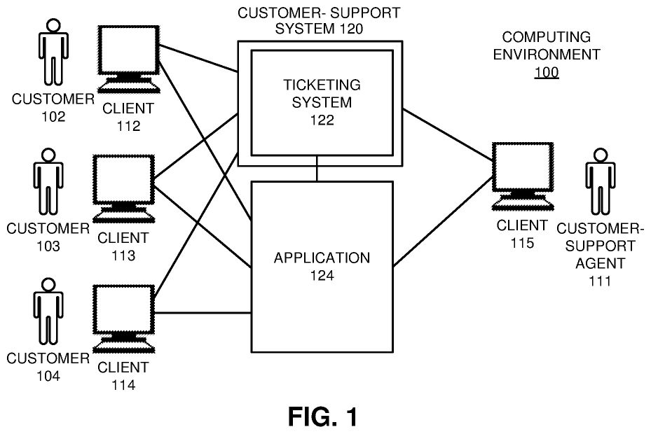

FIG. 1 illustrates an exemplary computing environment 100 in which a macro-suggestion service operates. At the highest level, computing environment 100 includes an application 124 and ticketing system 122. Within computing environment 100, a number of customers 102-104 interact with application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a customer-support system 120 to obtain help dealing with issues, which can include various problems and questions. For example, a user of accounting software may need help using a feature of the accounting software, or a customer of a website that sells sporting equipment may need help cancelling an order that was erroneously entered. This help may be provided by a customer-service agent 111 who operates a client computing system 115 and interacts with customers 102-104 through customer-support system 120. This help may also involve automatically suggested helpful articles that the customer can read to hopefully resolve the problem or question. Note that customer-service agent 111 can access application 124 (either directly or indirectly through customer-support system 120) to help resolve an issue.

In some embodiments, customer-support system 120 is not associated with computer-based application 124, but is instead associated with another type of product or service that is offered to a customer. For example, customer-support system 120 can provide assistance with a product, such as a television, or with a service such as a package-delivery service.

Customer-support system 120 organizes customer issues using a ticketing system 122, which generates tickets to represent each customer issue. Ticketing systems are typically associated with a physical or virtual “help center” (or “help desk”) for resolving customer problems. Ticketing system 122 comprises a set of software resources that enable a customer to resolve an issue. Specific customer issues are associated with abstractions called “tickets,” which encapsulate various data and metadata associated with the customer requests to resolve an issue. (Within this specification, tickets are more generally referred to as “customer requests.”) An exemplary ticket can include a ticket identifier, and information (or links to information) associated with the problem. For example, this information can include: (1) information about the problem; (2) customer information for one or more customers who are affected by the problem; (3) agent information for one or more customer-service agents who are interacting with the customer; (4) email and other electronic communications about the problem (which, for example, can include a question posed by a customer about the problem); (5) information about telephone calls associated with the problem; (6) timeline information associated with customer-service interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-service agent.

The operation of customer-support system 120 is described in further detail below.

### Customer-Support System

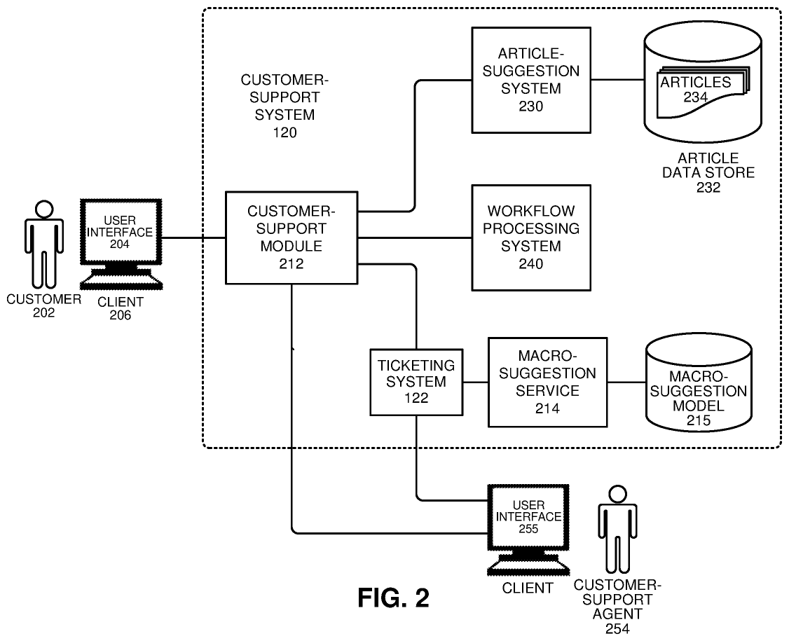

FIG. 2 illustrates how a customer 202 interacts with customer-support system 120 in accordance with the disclosed embodiments. A customer 202, who has an issue with a product or a service associated with application 124, interacts with customer-support system 120 through a user interface 204 in a client system 206. During this process, customer 202 submits a request to customer-support system 120 to obtain help with the issue, thereby initiating an automated customer-support interaction. (Note that user interface 204 can be implemented in a number of different ways for both mobile and desktop platforms. For example, user interface 204 can be incorporated into: a web page, an email, or a UI screen provided by an application.)

The request from customer 202 is directed to a customer-support module 212 within customer-support system 120. Customer-support module 212 can perform various responsive customer-support actions. For example, customer-support module 212 can cause customer 202 to receive one or more helpful articles from an article-suggestion system 230 to facilitate resolving the customer's issue. During this process, article-suggestion system 230 obtains the one or more helpful articles from a set of help center articles 234 contained in an article data store 232.

Customer-support module 212 can alternatively trigger a predefined workflow from workflow processing system 240 to help resolve the customer's issue. For example, the predefined workflow can be associated with one or more of the following: obtaining status information for an order; changing a delivery address for an order; issuing a refund for an order; issuing an exchange for an order; resetting the customer's password; updating details of the customer's account; and canceling the customer's account.

As another alternative, customer-support module 212 can put the customer 202 in touch with a human customer-support agent 254 to help resolve the customer's issue. The customer's issue will hopefully be resolved through one or more of these customer-support actions.

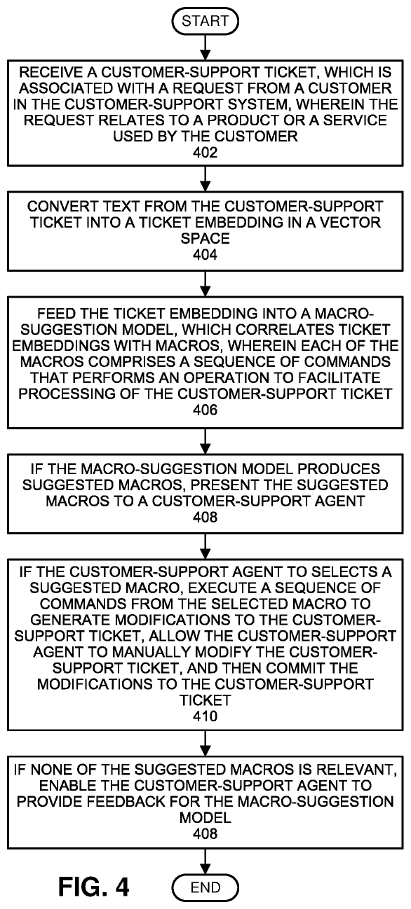

Customer-support module 212 makes use of ticketing system 122 (described above) to keep track of customer requests. To facilitate processing customer requests, tickets from ticketing system 122 are typically presented to customer-support agent 254 through a user interface 255. This enables customer-support agent 254 to make various modifications to the tickets to further processing of the associated customer requests. As mentioned above, these modifications often require customer-support agent 254 to manually input repetitive sequences of commands. To streamline this process, ticketing system 122 can make calls to a macro-suggestion service 214, which uses a macro-suggestion model 215 to produce recommendations for specific macros to facilitate common ticket modifications. Operations performed by macro-suggestion service 214 are described in more detail below with reference to the flow charts in FIGS. 4-6.

### Exemplary User Interface

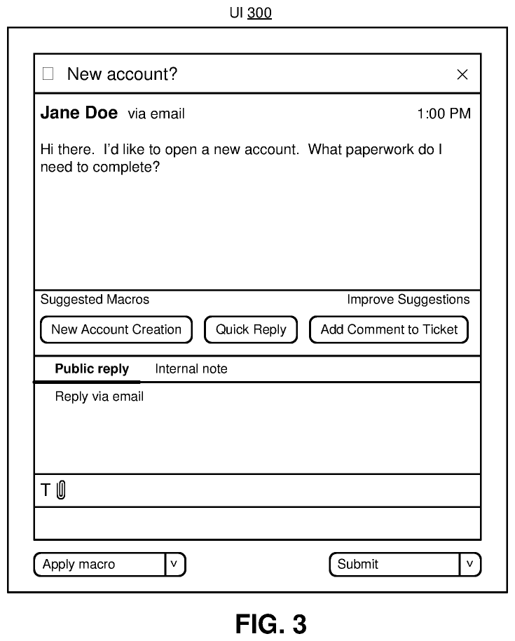

FIG. 3 illustrates an exemplary UI 300 that provides macro suggestions to a customer-support agent 254 in accordance with the disclosed embodiments. In this example, a user “Jane Doe” has sent a request in the form of an email to the online customer-support system 120 asking “What paperwork do I need to complete” to open a new account. This causes customer-support system 120 to create a ticket, which is sent to customer-support agent 254 to be processed. To enable customer-support agent 254 to process the ticket, the system sends text from this email to macro-suggestion service 214, which uses the text to identify the three most-relevant suggested macros, “New Account Creation,” “Quick Reply”, and “Add Comment to Ticket,” which are presented to customer support agent 254 through UI 300. Customer-support agent 254 then selects one of the macros to be “applied” to the ticket. The system then executes a sequence of commands from the selected macro to generate modifications to the customer-support ticket. At this point, the system allows customer-support agent 254 to enter additional manual modifications to the ticket prior to allowing customer-support agent 254 to “submit” the modifications.

Note that when the ticket is submitted, other “cascading actions” may automatically take place based on the ticket fields that have changed. For example, if the macro is used to set a “spam tag” in a ticket, after the agent submits the ticket, a cascading action can take place that moves the ticket to the spam folder.

### Macro-Suggestion Process

FIG. 4 presents a flow chart illustrating operations performed during the macro-suggestion process in accordance with the disclosed embodiments. During operation, the system receives a customer-support ticket, which is associated with a request from a customer in the customer-support system, wherein the request relates to a product or a service used by the customer (step 402). Next, the system converts text from the customer-support ticket into a ticket embedding in a vector space (step 404). The system then feeds the ticket embedding into a macro-suggestion model, which correlates ticket embeddings with macros, wherein each of the macros comprises a sequence of commands that performs an operation to facilitate processing of the customer-support ticket (step 406). If the macro-suggestion model produces suggested macros, the system presents the suggested macros to a customer-support agent (step 408). Then, if the customer-support agent selects a suggested macro, the system executes a sequence of commands from the selected macro to generate modifications to the customer-support ticket. The system then allows the customer-support agent to manually modify the customer-support ticket, and then commit the modifications to the customer-support ticket (step 410). On the other hand, if none of the suggested macros is relevant, the system enables the customer-support agent to provide feedback for the macro-suggestion model (step 412).

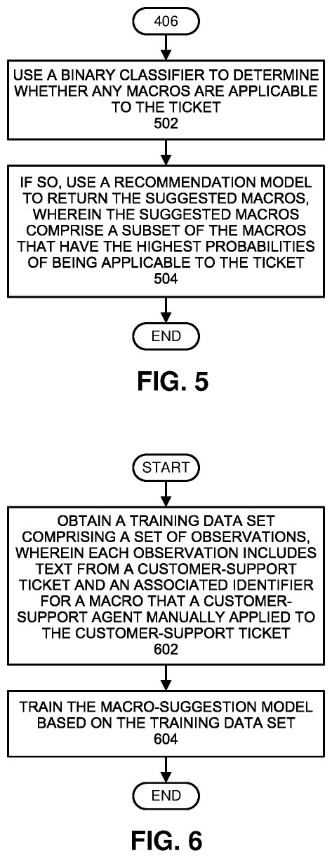

FIG. 5 presents a flow chart illustrating operations performed by the system while accessing the macro-suggestion model in accordance with the disclosed embodiments. (This flow chart illustrates in more detail the operations performed in step 406 of the flow chart illustrated in FIG. 4.) The system first uses a binary classifier to determine whether any macros are applicable to the ticket (step 502). If so, the system uses a recommendation model to return the suggested macros, wherein the suggested macros comprise a subset of the macros that have the highest probabilities of being applicable to the ticket (step 504).

FIG. 6 presents a flow chart illustrating operations performed while training the macro-suggestion model in accordance with the disclosed embodiments. During this process, the system obtains a training data set comprising a set of observations, wherein each observation includes text from a customer-support ticket and an associated identifier for a macro that a customer-support agent manually applied to the customer-support ticket (step 602). The system then trains the macro-suggestion model based on the training data set (step 604).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for automatically suggesting macros to help customer-support agents process customer-support tickets in an online customer-support system, comprising:
receiving a customer-support ticket, which is associated with a request from a customer in the customer-support system, wherein the request relates to a product or a service used by the customer;
converting text from the customer-support ticket into a ticket embedding in a vector space;
feeding the ticket embedding into a macro-suggestion model, which correlates ticket embeddings with macros, wherein each of the macros comprises a sequence of commands that performs an operation to facilitate processing of the customer-support ticket;
if the macro-suggestion model produces suggested macros, presenting the suggested macros to a customer-support agent; and
if the customer-support agent selects a suggested macro, facilitating application of the selected macro to the customer-support ticket.

2. The method of claim 1, wherein facilitating application of the selected macro to the customer-support ticket comprises:
executing the sequence of commands from the selected macro to generate modifications to the customer-support ticket; and
enabling the customer-support agent to commit the modifications to the customer-support ticket.

3. The method of claim 2, wherein after executing the sequence of commands from the selected macro, the method further comprises allowing the customer-support agent to manually modify the customer-support ticket prior to committing the modifications.

4. The method of claim 2, wherein after one or more modifications are committed to a customer-support ticket, the method further comprises performing one or more cascading actions based on the committed modifications.

5. The method of claim 1, wherein if none of the suggested macros is relevant, the method further comprises enabling the customer-support agent to provide feedback for the macro-suggestion model

6. The method of claim 1, wherein converting the text from the customer-support ticket into the ticket embedding comprises applying a universal sentence encoder to the text to produce the ticket embedding.

7. The method of claim 1, wherein the macro-suggestion model operates by:
using a binary classifier to determine whether any macros are applicable to the ticket; and
if so, using a recommendation model to return the suggested macros, wherein the suggested macros comprise a subset of the macros that have the highest probabilities of being applicable to the ticket.

8. The method of claim 1, wherein the macro-suggestion model includes a feed-forward neural network.

9. The method of claim 1, wherein prior to receiving the customer-support ticket, the method further comprises training the macro-suggestion model, which involves:
obtaining a training data set comprising a set of observations, wherein each observation includes text from a customer-support ticket and an associated identifier for a macro that a customer-support agent manually applied to the customer-support ticket; and
training the macro-suggestion model based on the training data set.

10. The method of claim 1, wherein an account-specific macro-suggestion model is used to process customer-support tickets associated with each account in the customer-support system.

11. The method of claim 1, wherein the method further comprises filtering suggested macros based on agent groups so that certain macros are accessible by specific agents or specific groups of agents.

12. The method of claim 1, wherein the macros can perform one or more of the following operations on customer-support tickets:
modifying a ticket field;
adding a comment to a ticket;
adding an attachment to a ticket comment;
adding a cc to a ticket;
adding or removing a ticket tag;
changing a priority of a ticket;
setting or changing a subject of a ticket;
setting or changing a status of a ticket;
setting or changing an assignee of a ticket; and
modifying a custom field in a ticket.

13. A non-transitory computer-readable storage medium storing instructions that when executed by a computer cause the computer to perform a method for automatically suggesting macros to help customer-support agents process customer-support tickets in an online customer-support system, the method comprising:
receiving a customer-support ticket, which is associated with a request from a customer in the customer-support system, wherein the request relates to a product or a service used by the customer;
converting text from the customer-support ticket into a ticket embedding in a vector space;
feeding the ticket embedding into a macro-suggestion model, which correlates ticket embeddings with macros, wherein each of the macros comprises a sequence of commands that performs an operation to facilitate processing of the customer-support ticket;
if the macro-suggestion model produces suggested macros, presenting the suggested macros to a customer-support agent; and
if the customer-support agent selects a suggested macro, facilitating application of the selected macro to the customer-support ticket.

14. The non-transitory computer-readable storage medium of claim 13, wherein facilitating application of the selected macro to the customer-support ticket comprises:
executing the sequence of commands from the selected macro to generate modifications to the customer-support ticket; and
enabling the customer-support agent to commit the modifications to the customer-support ticket.

15. The non-transitory computer-readable storage medium of claim 14, wherein after executing the sequence of commands from the selected macro, the method further comprises allowing the customer-support agent to manually modify the customer-support ticket prior to committing the modifications.

16. The non-transitory computer-readable storage medium of claim 14, wherein after one or more modifications are committed to a customer-support ticket, the method further comprises performing one or more cascading actions based on the committed modifications.

17. The non-transitory computer-readable storage medium of claim 13, wherein if none of the suggested macros is relevant, the method further comprises enabling the customer-support agent to provide feedback for the macro-suggestion model.

18. The non-transitory computer-readable storage medium of claim 13, wherein converting the text from the customer-support ticket into the ticket embedding comprises applying a universal sentence encoder to the text to produce the ticket embedding.

19. The non-transitory computer-readable storage medium of claim 13, wherein the macro-suggestion model operates by:
using a binary classifier to determine whether any macros are applicable to the ticket; and
if so, using a recommendation model to return the suggested macros, wherein the suggested macros comprise a subset of the macros that have the highest probabilities of being applicable to the ticket.

20. The non-transitory computer-readable storage medium of claim 13, wherein the macro-suggestion model includes a feed-forward neural network.

21. The non-transitory computer-readable storage medium of claim 13, wherein prior to receiving the customer-support ticket, the method further comprises training the macro-suggestion model, which involves:
obtaining a training data set comprising a set of observations, wherein each observation includes text from a customer-support ticket and an associated identifier for a macro that a customer-support agent manually applied to the customer-support ticket; and
training the macro-suggestion model based on the training data set.

22. The non-transitory computer-readable storage medium of claim 13, wherein an account-specific macro-suggestion model is used to process customer-support tickets associated with each account in the customer-support system.

23. The non-transitory computer-readable storage medium of claim 13, wherein the method further comprises filtering suggested macros based on agent groups so that certain macros are accessible by specific agents or specific groups of agents.

24. The non-transitory computer-readable storage medium of claim 13, wherein the macros can perform one or more of the following operations on customer-support tickets:
modifying a ticket field;
adding a comment to a ticket;
adding an attachment to a ticket comment;
adding a cc to a ticket;
adding or removing a ticket tag;
changing a priority of a ticket;
setting or changing a subject of a ticket;
setting or changing a status of a ticket;
setting or changing an assignee of a ticket; and
modifying a custom field in a ticket.

25. A system that automatically suggests macros to help customer-support agents process customer-support tickets in an online customer-support system, comprising:
at least one processor and at least one associated memory; and
a suggestion mechanism, which executes on the at least one processor, wherein during operation, the suggestion mechanism:
receives a customer-support ticket, which is associated with a request from a customer in the customer-support system, wherein the request relates to a product or a service used by the customer;
converts text from the customer-support ticket into a ticket embedding in a vector space;
feeds the ticket embedding into a macro-suggestion model, which correlates ticket embeddings with macros, wherein each of the macros comprises a sequence of commands that performs an operation to facilitate processing of the customer-support ticket;
if the macro-suggestion model produces suggested macros, presents the suggested macros to a customer-support agent; and
if the customer-support agent selects a suggested macro, facilitates application of the selected macro to the customer-support ticket.

26. The system of claim 25, wherein while facilitating application of the selected macro to the customer-support ticket, the suggestion mechanism:
executes the sequence of commands from the selected macro to generate modifications to the customer-support ticket; and
enables the customer-support agent to commit the modifications to the customer-support ticket.

27. The system of claim 26, wherein after executing the sequence of commands from the selected macro, the suggestion mechanism allows the customer-support agent to manually modify the customer-support ticket prior to committing the modifications.

28. The system of claim 26, wherein after one or more modifications are committed to a customer-support ticket, the suggestion mechanism performs one or more cascading actions based on the committed modifications.

29. The system of claim 25, wherein if none of the suggested macros is relevant, the suggestion mechanism enables the customer-support agent to provide feedback for the macro-suggestion model.
